(19) United States
(12) Patent Application Publication
(10) Pub. No.: US 2014/0189795 A1
(43) Pub. Date: Jul. 3, 2014

(54) Method and Apparatus for Conducting Service by Service Delivery Platform

(71) Applicant: Huawei Technologies Co., Ltd., Shenzhen (CN)

(72) Inventors: Fan Zhang, Wuhan (CN); Honglin Liu, Madrid (ES); Fan Chen, Dubai (AE)

(73) Assignee: Huawei Technologies Co., Ltd., Shenzhen (CN)

(21) Appl. No.: 14/197,478

(22) Filed: Mar. 5, 2014

Related U.S. Application Data
(63) Continuation of application No. PCT/CN2012/082410, filed on Sep. 29, 2012.

(30) Foreign Application Priority Data
Mar. 9, 2012 (CN) 201210060975.4

(51) Int. Cl. H04L 29/06

(52) U.S. Cl. CPC H04L 63/08; H04L 63/083
USPC 726/3

(57) ABSTRACT

A method for conducting a service by a service delivery platform (SDP) and an SDP are provided. By means of the method for opening a service capability by a provided SDP, the time required for introduction of a new capability to the SDP can be reduced, being advantageous in implementation of rapid launching of a new service.

### CROSS-REFERENCE TO RELATED APPLICATIONS

This application is a continuation of International Application No. PCT/CN2012/082410, filed on Sep. 29, 2012, which claims priority to Chinese Patent Application No. 201210060975.4, filed on Mar. 9, 2012, both of which are hereby incorporated by reference in their entireties.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates to the field of communications technologies, and in particular, to a method and apparatus for conducting a service by a service delivery platform.

### BACKGROUND

The service scope of a current telecommunication operator is no longer limited to conventional telecommunication basic services, and various flexible value-added telecommunication services with abundant user experience spring up. A service delivery platform (SDP) emerges against this background. The SDP integrates various telecommunication capabilities into a system, and opens the capabilities to a third party in a ParlayX or One Application Programming Interface (API) interface manner, so that the third party does not need to understand complex telecommunication protocols, but focuses on service logic. The opening of telecommunication capabilities by the SDP enables a service provider (SP) to rapidly develop various applications that have abundant functions.

Along with the rapid development of the mobile Internet, the telecommunication operator expects to open more telecommunication capabilities or introduce an Internet capability to open for the SP, so that the SP develops more valuable applications. However, capabilities defined in current ParlayX and OneAPI are limited, and cannot satisfy requirements of the SP and the telecommunication operator.

In the prior art, in order to implement access and the opening of a new telecommunication capability or Internet capability, it is required to conduct the following development works in multiple subsystems in the SDP: implementing corresponding telecommunication or Internet capability access and protocol conversion on a “capability access subsystem”, where an interface to the new capability is usually of a new interface type, and the “capability access subsystem” requires implementing conversion between an internal interface protocol of the SDP and an interface protocol provided by the new capability; implementing an internal interface protocol related to the capability on an “integrated bus subsystem”, and implementing related orchestration logic, such as initiating authentication and charging; and implementing a related internal interface and external development interface of the capability (generally, the two are consistent) on a “service access subsystem”, and implementing a service level agreement (SLA) control related to the capability, and the like.

It can be seen that, every time a new capability is opened in the SDP, development and joint debugging of various components are involved, and the SP is required to be familiar with various different non-standard interfaces, which causes large end-to-end time consumption, and is disadvantageous in rapid production and launching of a third-party service.

### SUMMARY

Embodiments of the present invention solve the problem in the prior art that it requires coordinative development of multiple components and a long development period for an SDP to newly add a capability.

An embodiment of the present invention provides a method for conducting a service by an SDP, including: receiving, by an SDP, a service request sent by an SP, where the service request includes public information and service information; performing access authentication on the SP according to the public information in the service request, to determine routing of the service request in the SDP; determining, according to the public information in the service request, a service capability called by the service request, and determining, according to the service information in the service request, information required for calling the service capability; converting the service request into an interface supported by a service capability function module that provides the service capability; and sending the converted service request to the service capability function module.

Another embodiment of the present invention further provides an SDP, including: a service access subsystem configured to receive a service request sent by an SP, and perform access authentication on the SP, where the service request includes public information and service information; an integrated bus subsystem configured to determine routing of the service request in the SDP; and a capability access subsystem configured to determine a service capability called by the service request, and convert the service request into an interface supported by a service capability module that provides the service capability.

By means of the method for conducting a service by a service delivery platform provided in the embodiment of the present invention, when accessing a new telecommunication capability or Internet capability into the SDP, it is only required to perform corresponding customization on the “capability access subsystem” to implement conversion between an external interface and an internal interface, and the “service access subsystem” and the “integrated bus subsystem” are not required to be customized, so that the time required for introduction of a new capability to the SDP is reduced, which is advantageous in implementation of rapid launching of a new service.

### BRIEF DESCRIPTION OF THE DRAWINGS

FIG. 1 is a schematic diagram of SDP service capability opening architecture according to an embodiment of the present invention;

FIG. 2 is a signaling flow chart of an SP developing, based on a multimedia message capability opened by an SDP, a service of delivering a mobile phone newspaper to a subscriber according to an embodiment of the present invention;

FIG. 3 is a signaling flow chart of a terminal user subscribing a mobile phone newspaper service according to an embodiment of the present invention;

FIG. 4 is a signaling flow chart of an SP sending a mobile phone newspaper to a terminal user through an SDP according to an embodiment of the present invention;

FIG. 5 is a signaling flow chart of synchronous service delivery where generalRequest is adopted according to an embodiment of the present invention;

FIG. 6 is a signaling flow chart of asynchronous service delivery where generalRequest is adopted according to an embodiment of the present invention;

FIG. 7 is a flow chart of “integrated bus subsystem error reporting” where generalError is adopted according to an embodiment of the present invention;

FIG. 8 is a flow chart of “capability access subsystem error reporting” where generalError is adopted according to an embodiment of the present invention;

FIG. 9 is a flow chart of a synchronous service request where generalNotify is adopted according to an embodiment of the present invention;

FIG. 10 is a flow chart of an asynchronous service request where generalNotify is adopted according to an embodiment of the present invention;

FIG. 11 is a signaling flow chart of processing a simple service in an SDP according to an embodiment of the present invention; and

FIG. 12A, FIG. 12B, and FIG. 12C are a processing flow chart of internal subsystems when an SDP processes a complex service scenario according to an embodiment of the present invention.

### DETAILED DESCRIPTION

For ease of understanding and implementation of the present invention by a person of ordinary skill in the art, embodiments of the present invention are described with reference to accompanying drawings.

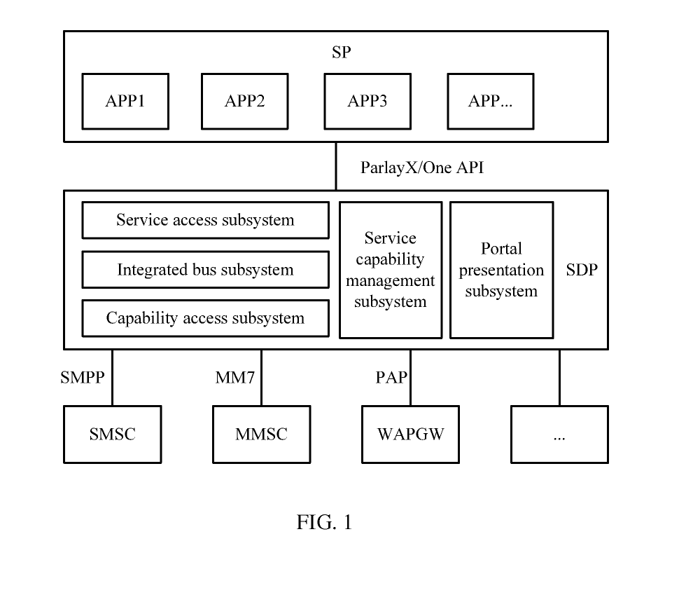

FIG. 1 is a schematic diagram of SDP capability opening architecture. An SP is connected to an SDP through a ParlayX or One API interface, and a function of each subsystem inside the SDP is described as follows:

A “service access subsystem” is responsible for access authentication of a third-party service, SLA control, and the like; an “integrated bus subsystem” is responsible for service request routing, protocol conversion, capability orchestration (such as charging), and the like; a “capability access subsystem” is responsible for access of telecommunication and non-telecommunication capabilities, and converts a conventional telecommunication protocol into an internal protocol of the SDP; a “service capability management subsystem” is responsible for management of service and capability, charging, and the like; and a “portal presentation subsystem” is responsible for providing a terminal user with service representation and a channel of service subscription and unsubscription.

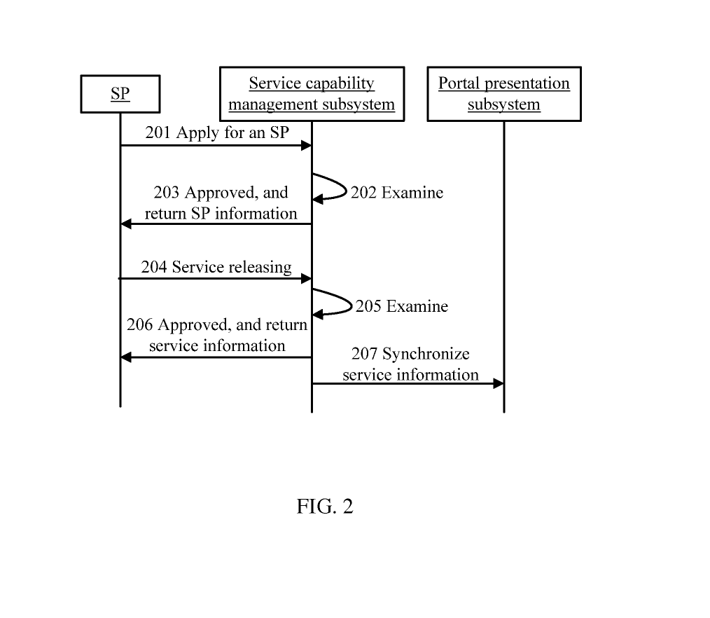

With reference to the system architectural diagram of the SDP in FIG. 1, FIG. 2 shows a signaling flow chart of an SP developing, based on a multimedia message capability opened by an SDP, a service of delivering a mobile phone newspaper service to a subscriber, and according to the drawing, a procedure of the SP releasing a mobile phone newspaper service is as follows:

The SP first needs to apply for an SP identity on the SDP through the “service capability management subsystem”, after getting approval, the SP releases a mobile phone newspaper service on the “service capability management subsystem” by using the SP identity, and after a manager approves the service, information (such as service description and price) of the mobile phone newspaper service is presented on the “portal presentation subsystem”, so that the terminal user can subscribe to the mobile phone newspaper service.

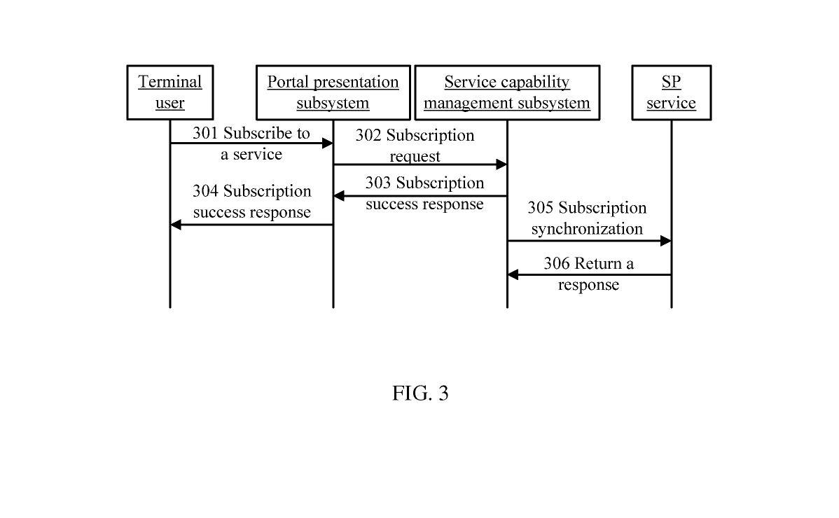

After the terminal user subscribes to the mobile phone newspaper service, the SDP synchronizes a subscription relationship to the mobile phone newspaper service. The procedure is shown in FIG. 3.

The terminal user first presents, through a portal of the SDP, that a subsystem subscribes to the mobile phone newspaper service, and the service capability management subsystem responds to it and synchronizes the subscription relationship to the mobile phone newspaper service.

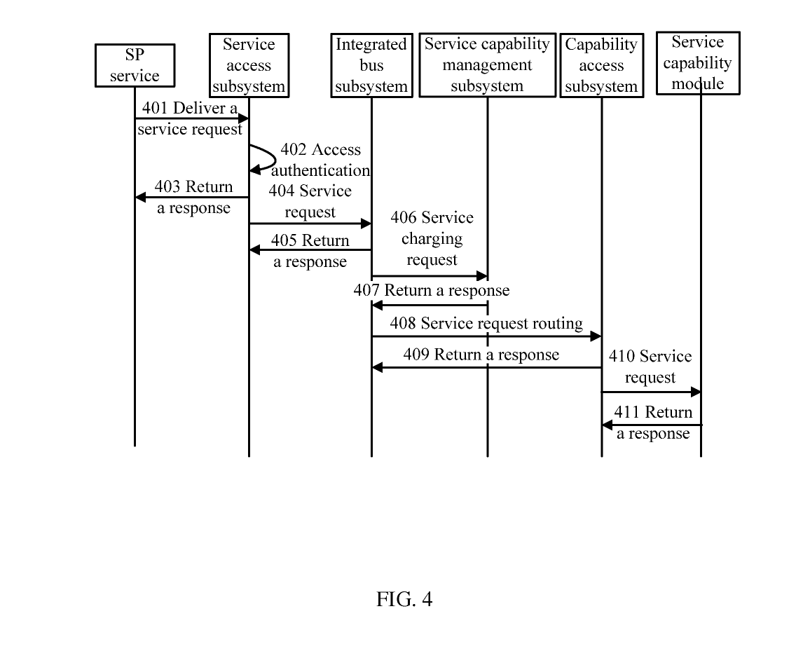

Through the procedures shown in FIG. 2 and FIG. 3, the SP completes the releasing of the mobile phone newspaper service, and the terminal user completes the service subscription. FIG. 4 shows a signaling procedure of an SP sending a mobile phone newspaper to a terminal user through an SDP.

Steps 401-403: A mobile phone newspaper service provided by the SP sends information to a “service access subsystem” through a ParlayX or One API interface, and the “service access subsystem” performs access authentication and SLA control on the SP's access request of this time, where the SLA control may include multiple levels, including but not limited to a system level, a business level, an SP level, a user level, a service level, and the like. After the authentication is passed, a response is returned to the SP.

Steps 404-405: The “service access subsystem” forwards the request to an “integrated bus subsystem”, and receives a response returned by the “integrated bus subsystem”.

Steps 406-407: The “integrated bus subsystem” analyzes charging information of the service, triggers a charging request to the “service capability management subsystem”, and receives a response that is returned by the “service capability management subsystem” in response to the request.

Steps 408-409: After charging of the “service capability management subsystem” succeeds, the “integrated bus subsystem” determines routing information of the request, routes the request to a corresponding “capability access subsystem” (there may be multiple “capability access subsystems” in the network, for example, multinational networking), and receives a response returned by the “capability access subsystem”.

Steps 410-411: The “capability access subsystem”, after receiving the request, converts the request into a mobile multimedia message (MM7) protocol, and sends the request to a multimedia message service center (MMSC), and the MMSC sends a corresponding mobile phone newspaper multimedia message to the terminal user.

An embodiment of the present invention provides a method for conducting a service by an SDP, so that an SP does not need to develop an interface for each new capability.

A specific implementation manner is that: an interface between a “service access subsystem” and the SP is defined as a general interface, and internal logic function components of the SDP also communicate with each other by adopting the general interface.

The general interface includes two parts of contents: one part is public information, such as SP identity information, service information, and authentication information; the other part is service information, which is generally referred to as specific information of a service, is related to a capability required to be called in the service, and includes information required for calling the capability. For example, as for a service request of a weather query, it is required to include, in the service information, information such as a city and time of to-be-provided weather information; when a capability of querying what a product price is, it is required to provide information such as a product location, a product name, or a product bar code.

According to requirements of a service scenario, three general interfaces may be defined. One is used for the SP to send a request to the SDP, and may be named as generalCall; one is used for the SDP to send a request to the SP, and may be named as generalNotify; and one is used for the SDP to process an error and used to send an error notification to the SP, and may be named as generalError. The foregoing general interface may be a WebService interface, and may be in a form of simple object access protocol (SOAP), representational state transfer (REST) or another interface form that can be rapidly developed by the SP.

Interface fields are illustrated as follows through examples.

generalCall:

| Message Name | | Field Name | Description |
|---|---|---|---|
| generalCallRequest | Public part | spId | An SPId for which an SP applies on |
| | | | an SDP platform |
| | | SpPassword | An SPI password for which an SP |
| | | | applies on an SDP platform |
| | | serviceId | A corresponding serviceId |
| | | timeStamp | A request time stamp |
| | | operateId | An operation Id identifier, used as: |
| | | | 1. a reference for an “integrated bus |
| | | | subsystem” to perform routing; and |
| | | | 2. a reference for a “capability access |
| | | | subsystem” to perform protocol |
| | | | conversion. |
| | | userId | An identity of a terminal |
| | Service part | Related to a specific capability | |
| generalCallResponse | Public part | transId | A session Id |

| | |
|---|---|
| Service part | Related to a specific capability |

generalNotify:

| Message Name | | Field Name | Description |
|---|---|---|---|
| generalNotifyRequest | Public part | transId | A session Id |
| | | spRevId | An Id for the SP to verify an SDP |
| | | | identity |
| | | spRevpassword | A password for the SP to verify an |
| | | | SDP identity |
| | | spId | A provider Id of a service |
| | | | corresponding to the request |
| | | serviceId | A service ID corresponding to the |
| | | | request |
| | | operateId | An operation Id identifier, used for |
| | | | the SP service to understand a |
| | | | current operation |
| | | userId | An identity of a terminal |

| | | |
|---|---|---|
| | Service part | Related to a specific capability |
| generalNotifyResponse | Public part | Null |
| | Service part | Null |

generalError:

| Message Name | | Field Name | Description |
|---|---|---|---|
| generalErrorRequest | Public part | transId | A session Id |
| | | errorCode | An error code |
| | | errorDescription | Description |
| | | | of an error |

| | | |
|---|---|---|
| | Service part | Related to a specific capability |
| generalErrorResponse | Public part | Null |
| | Service part | Null |

According to the three types of general interfaces provided in the foregoing embodiment, an embodiment of the present invention provides a corresponding procedure of conducting a service by an SDP.

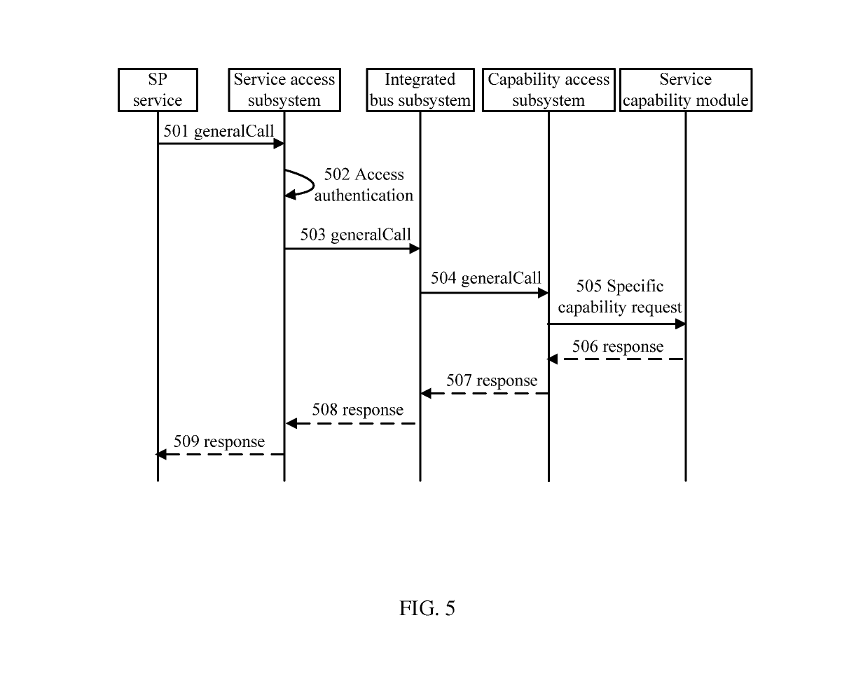

FIG. 5 is a signaling flow chart of synchronous service delivery where generalRequest is adopted. It can be seen from FIG. 5 that, an interface between the SP and the “service access subsystem” is a general interface defined in the foregoing embodiment, and subsystems in the SDP also communicate with each other by adopting the general interface. In this way, it is only required to perform customization on the “capability interface subsystem” to implement conversion between the internal general interface and an interface supported by a service capability module that provides the service capability, thereby greatly simplifying the development procedure, and implementing rapid launching of a new service.

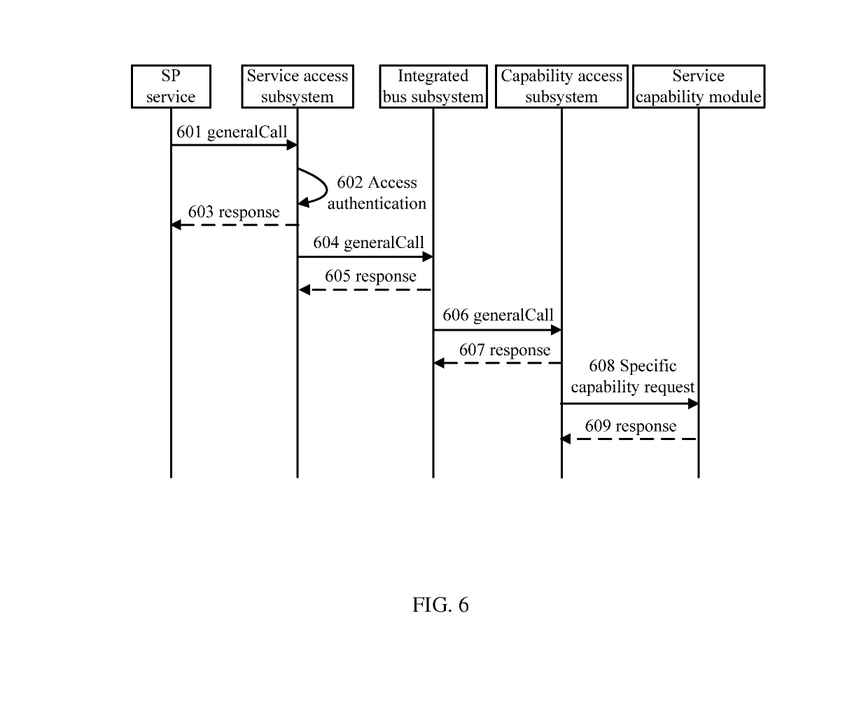

FIG. 6 is a signaling flow chart of asynchronous service delivery where generalRequest is adopted, and whether a procedure is synchronous or asynchronous is determined according to an operateId field in generalCall defined in the foregoing.

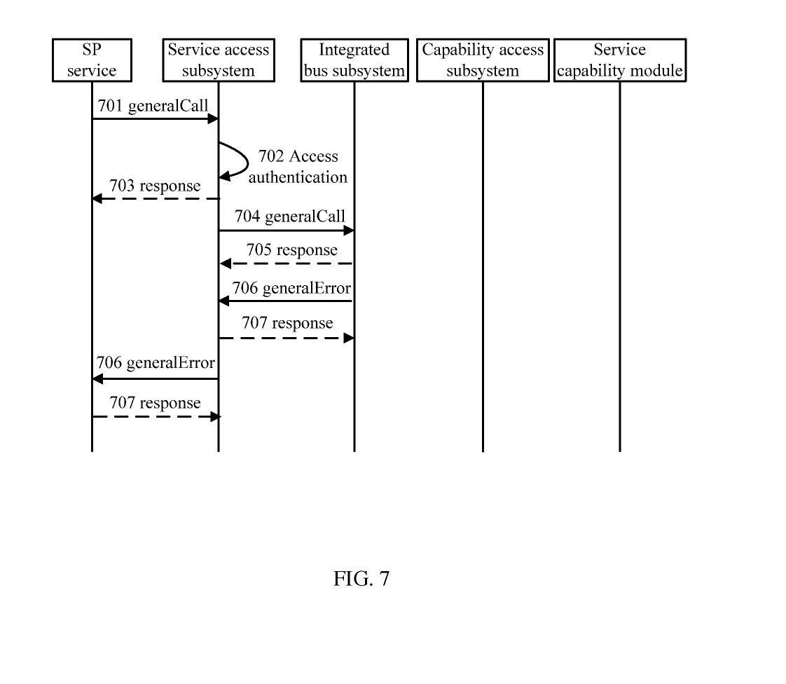

FIG. 7 is a procedure of “integrated bus subsystem error reporting” where generalError is adopted.

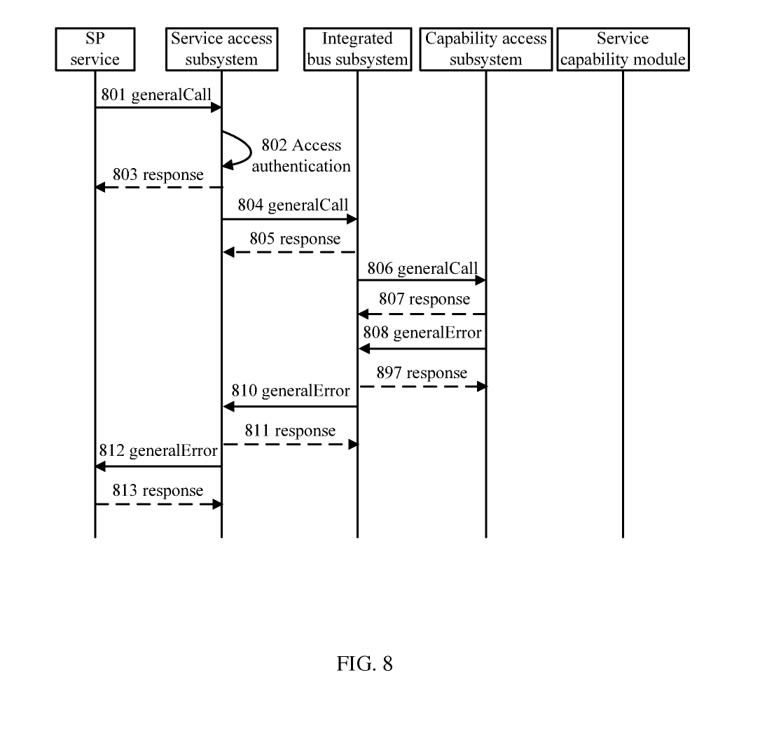

FIG. 8 is a procedure of “capability access subsystem error reporting” where generalError is adopted.

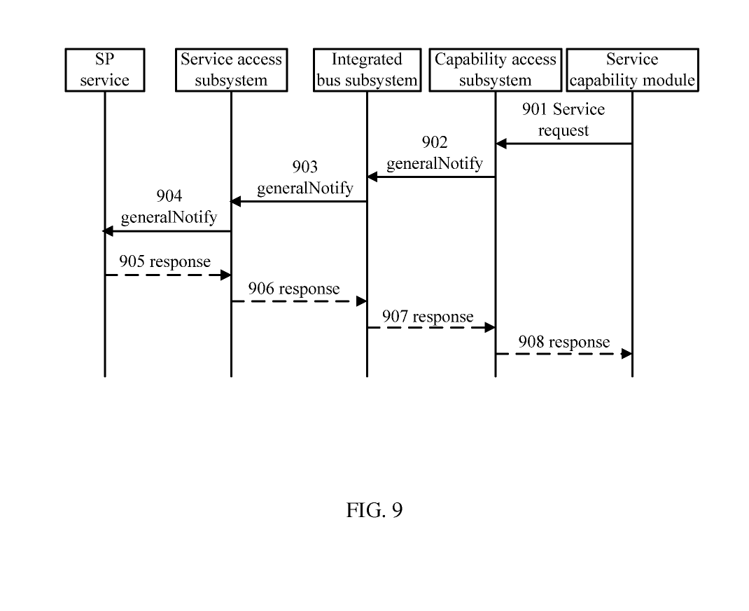

FIG. 9 is a procedure of a synchronous service request where generalNotify is adopted.

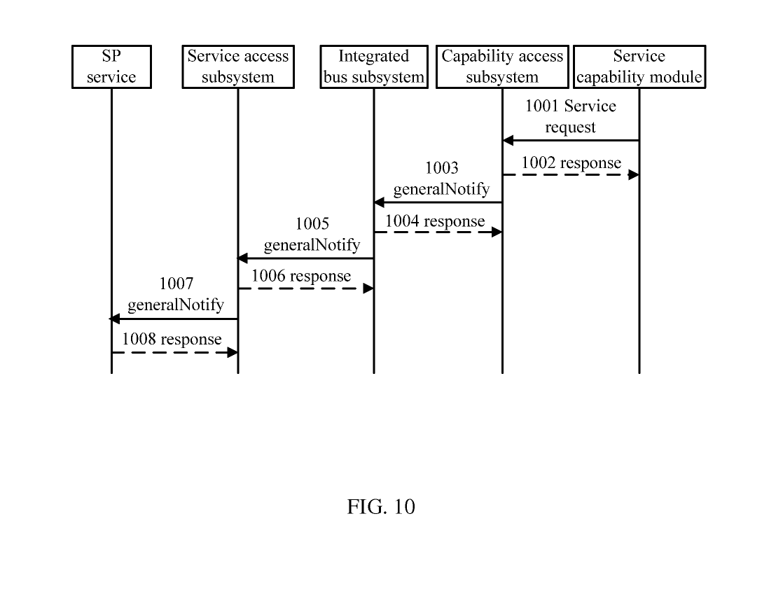

FIG. 10 is a procedure of an asynchronous service request where generalNotify is adopted.

By adopting the procedures of performing communication by using the general interface disclosed in FIG. 5 to FIG. 10, the interface between the “service access subsystem” and the SP is defined as the general interface, and internal components of the SDP also communicate with each other by adopting the general interface, so that when a new telecommunication capability or Internet capability is accessed to the SDP, it is only required to perform corresponding customization on the “capability access subsystem” to implement conversion between an external interface and an internal interface, and the “service access subsystem” and the “integrated bus subsystem” both do not need to be customized, so that the time required for introduction of a new capability to the SDP is reduced, which is advantageous in implementation of rapid launching of a new service.

In a current SDP simple service scenario, the SDP integrates a service capability provided by an external service capability module, and generally, the SDP is used as a pure service channel and does not need to perform complex service logic orchestration (a scenario requiring performing complex service logic orchestration is that, for example, the SP sends a short message to a user, a subsequent short message state report reaches the SDP, and the SDP needs to find a record cached when originally delivering the short message so as to update the recorded state). As for the scenario, the method disclosed in the embodiment of the present invention may be applied where a general interface is adopted, thereby avoiding customization of a new interface and service logic on the “service access subsystem” and the “integrated bus subsystem”.

As for a service scenario requiring complex service logic orchestration, the general interface disclosed in the embodiment of the present invention is used, and it is further required to newly add a customization module, which may be named as, for example, a “service logic processing subsystem”, in the SDP so as to implement customization of service logic. After the “service logic processing subsystem” is newly added, when the SDP processes a complex service requiring logic orchestration, after a service request (applicable to a scenario initiated by the SP and a scenario initiated by a terminal user) sent by the general interface provided in the embodiment of present invention, for example, generalCallRequest, reaches the “integrated bus subsystem”, the “integrated bus subsystem” determines, according to “operateId” in the public part of the request message, whether the request needs to be routed to the “service logic processing subsystem” for processing. The “integrated bus subsystem” and the “service logic processing subsystem” also communicate with each other by adopting the general interface defined in the SDP, for example, generalCallRequest. The “service logic processing subsystem” analyzes content of a Service Party part in service information corresponding to the request message, and performs corresponding service logic processing, where the processing may involve operations such as system internal operation, storing context session, and calling a peripheral subsystem interface.

Procedures of processing the simple service and complex service by applying the method disclosed in the embodiment of the present invention are illustrated in the following through specific examples.

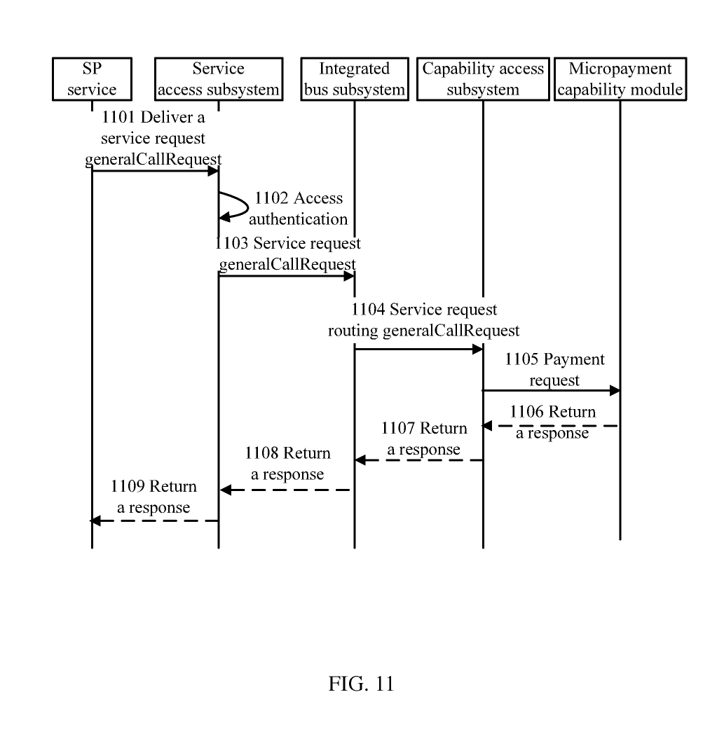

For example, a micropayment capability is integrated in the SDP, and a service developed by the SP can call the micropayment capability to collect the payment of a service for the terminal user. FIG. 11 is a signaling flow chart of processing the simple service in the SDP.

It can be seen from FIG. 11 that, the procedure only involves calling of a micropayment capability, and steps 1101, 1103 and 1104 in the procedure may all use the general interface generalCallRequest disclosed in the embodiment of the present invention. The “service access subsystem” performs access authentication according to the spId field and spPassword field in the general interface, and performs SLA control at the same time, where the SLA control may include many levels, including, but not limited to, a system level, a business level, an SP level, a user level, a service level, and the like. For example, corresponding service-level and SP-level SLA control may be performed according to field information such as serviceId and spId. The “integrated bus subsystem” determines routing of the message according to the operateId field in the general interface. In this example, it is determined, according to the operateId, that the request needs to be routed to the “capability access subsystem” for processing. The “capability access subsystem” converts, according to a specific protocol conversion rule determined by the operateId, the general request into an interface supported by a payment capability module that provides the payment capability.

It can be seen from the example of the foregoing application scenario that, the new capability is integrated into the SDP by using the general interface, the “service access subsystem” and the “integrated bus subsystem” both do not need related development, and therefore, it is possible that limited interfaces are adopted between two subsystems to support unlimited service scenarios.

How to implement, by applying the general interface and the “service logic processing subsystem” provided in the embodiment of the present invention, a complex service scenario application requiring performing service logic orchestration is illustrated specifically through an example of an application scenario where an SDP delivers a weather forecast service to a user terminal.

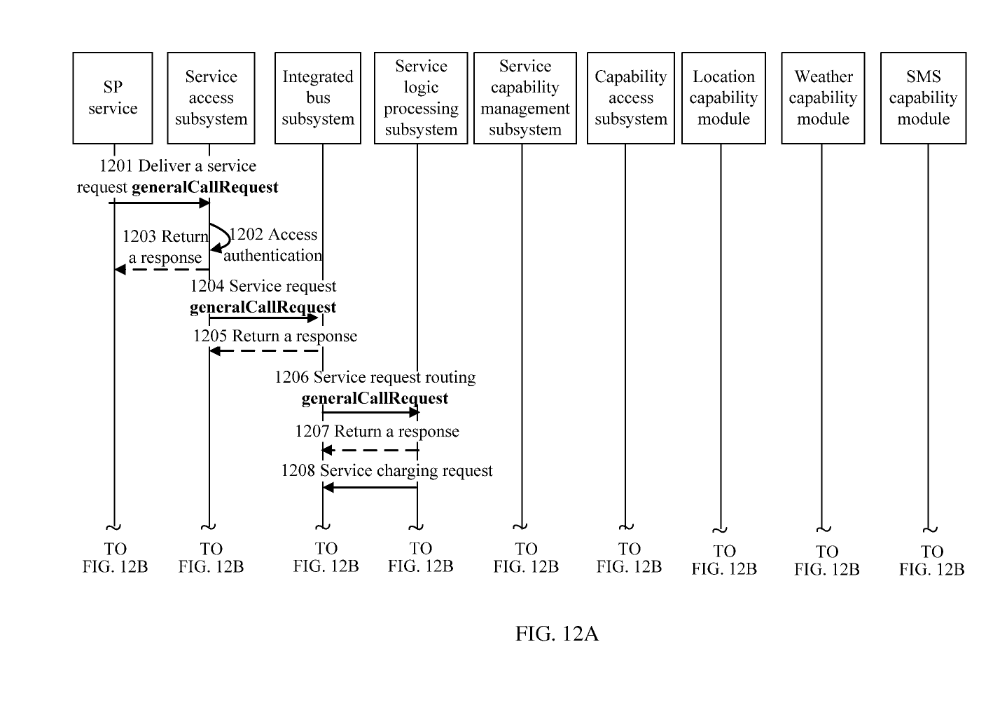

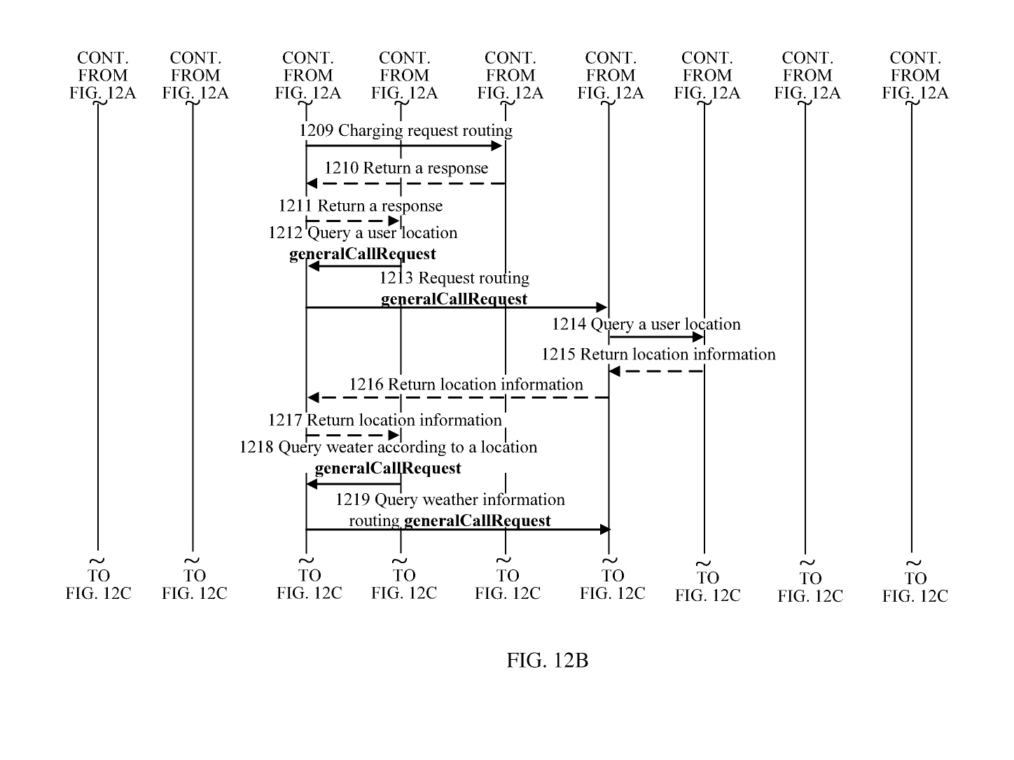

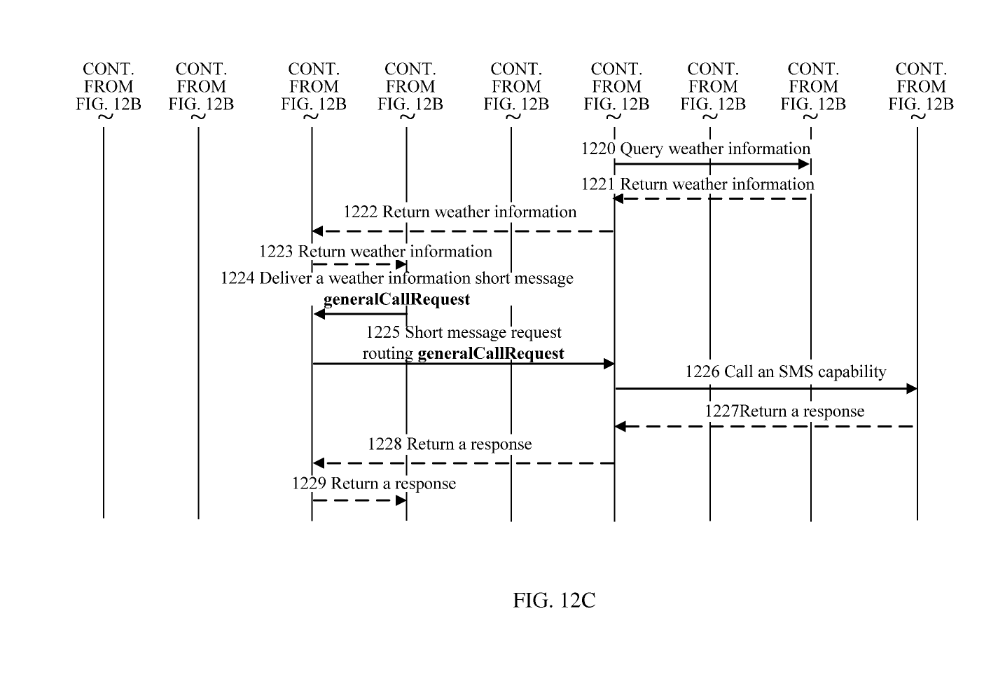

FIG. 12A, FIG. 12B, and FIG. 12C are a processing flow chart of internal subsystems when an SDP processes a complex service scenario.

The complex application scenario processing described in the following involves combined calling of three types of SDP capabilities, including location, weather and short message service (SMS) capabilities, and introduces a “service logic processing subsystem” to implement customization of service logic.

It can be seen from FIG. 12A, FIG. 12B, and FIG. 12C that, in all the steps 1201, 1204, 1206, 1212, 1213, 1218, 1219, 1224 and 1225, the general interface format generalCallRequest provided in the embodiment of the present invention can be used. The “service access subsystem” may perform access authentication according to the spId field and the spPassword field in the general interface, and at the same time, performs corresponding service-level and SP-level SLA control according to field information such as serviceId and spId. The “integrated bus subsystem” determines routing of the request message according to the operateId field in the general interface, and during the processing of the complex application scenario described in this embodiment, the “integrated bus subsystem” determines, according to the operateId field, that the request needs to be routed to the “service logic processing subsystem” for processing. The “service logic processing subsystem” finds, according to the operateId field, service logic that needs to be executed, where different operateId fields correspond to different processing logic. In this embodiment, it is required to correspondingly call three different kinds of logic including a location capability, a weather capability and a short message capability.

From the application scenario described in the foregoing, it can be seen that, in addition to being capable of rapidly and efficiently implementing access of a single capability, the general interface disclosed in the embodiment of the present invention can further provide various capabilities of the SDP to the SP in a combination manner through cooperation with the “service logic processing subsystem”, so that the SP can implement development and launching of the service more rapidly. In the complex application scenario involving calling of three types of capabilities described in this example, if a conventional development manner is adopted, the SP needs to interact with the SDP for 3 times, but only one interaction is required when adopting the solution provided in the embodiment of the present invention.

In the embodiment of the present invention, a general interface is adopted to implement a capability interface that is not defined in a ParlayX/OneAPI specification. From the two specific application scenarios disclosed in the foregoing, it can be seen that using the general interface reduces the number of interface for interaction between internal components of the SDP, so that the SDP platform can access a new capability more rapidly. Using the general interface can further enable the SP to focus on service development instead of development of various interfaces, so that the speed of the SP developing a new service is accelerated. By further adopting the “service logic processing subsystem” provided in the embodiment of the present invention, the combined capabilities of the SDP can be provided, through a single general interface, for the SP to use, so that the service development by the SP becomes simpler, thereby reducing development cost of the SP and reducing launching time of a new service.

A person skilled in the art may be aware that, in combination with the examples described in the embodiments disclosed in this specification, method steps and units may be implemented by electronic hardware, computer software, or a combination thereof. To clearly describe the interchangeability between the hardware and the software, the foregoing has generally described steps and compositions of each embodiment according to functions. Whether the functions are performed by hardware or software depends on particular applications and design constraint conditions of the technical solutions. A person skilled in the art may use different methods to implement the described functions for each particular application, but it should not be considered that the implementation goes beyond the scope of the present invention.

Steps of methods described in the embodiments of the present invention can be implemented through hardware, software program executed by a processor, or a combination thereof. The software program may be placed in a random access memory (RAM), a memory, a read-only memory (ROM), an electrically programmable ROM, an electrically erasable and programmable ROM, a register, a hard disk, a mobile magnetic disk, a compact disc read-only memory (CD-ROM), or a storage medium of any other form well-known in the art.

Some embodiments of the present invention are shown and described; however, a person skilled in the art should understand that various modifications can be made on the embodiments without departing from the principle and spirit of the present invention, and the modifications shall fall within the scope of the present invention.

What is claimed is:

1. A method for conducting a service by a service delivery platform (SDP), comprising:
receiving, by the SDP, a service request sent by a service provider (SP), wherein the service request comprises public information and service information;
performing access authentication on the SP according to the public information in the service request to determine routing of the service request in the SDP;
determining, according to the public information in the service request, a service capability called by the service request, and determining, according to the service information in the service request, information required for calling the service capability;
converting the service request into an interface supported by a service capability module that provides the service capability; and
sending the converted service request to the service capability module.

2. The method according to claim 1, wherein determining routing of the service request in the SDP specifically comprises routing the service request to a service logic processing subsystem for processing.

3. The method according to claim 1, wherein after performing, by the SDP, access authentication on the SP, to determine routing of the service request in the SDP, the method further comprises performing service level agreement (SLA) control according to the public information in the service request.

4. The method according to claim 1, wherein the public information in the service request at least comprises one of the following contents: an identity spId for which the SP applies on the SDP, a password spPassword which the SP set on the SDP, a service identifier serviceId corresponding to the service request, a time stamp timestamp of the service request, an operation ID identifier operateId, and a terminal identity userId.

5. The method according to claim 4, wherein performing access authentication on the SP according to the public information in the service request specifically comprises performing access authentication on the SP according to the identity spId for which the SP applies on the SDP and the password spPassword which the SP set on the SDP, wherein the identity spId and the password spPassword are comprised in the public information.

6. The method according to claim 4, wherein performing SLA control according to the public information in the service request comprises performing service-level SLA control according to the service identifier serviceId corresponding to the service request, wherein the service identifier serviceId is comprised in the public information, and performing SP-level SLA control according to the identity spId for which the SP applies on the SDP, wherein the identity spId is comprised in the public information.

7. The method according to claim 4, wherein determining routing of the service request in the SDP according to the public information in the service request specifically comprises determining routing of the service request in the SDP according to the operation ID identifier operateId comprised in the public information.

8. The method according to claim 4, wherein determining, according to the public information in the service request, the service capability called by the service request, and converting the service request into the interface supported by the service capability module that provides the service capability specifically comprise:
determining, according to the operation ID identifier operateId comprised in the public information, a service capability called by the service request;
determining a protocol conversion rule according to the operateId; and
converting, according to the protocol conversion rule, the service request into an interface supported by the service capability module that provides the service capability.

9. A service delivery platform (SDP), comprising:
a service access subsystem configured to receive a service request sent by a service provider (SP), and perform access authentication on the SP, wherein the service request comprises public information and service information;
an integrated bus subsystem configured to determine routing of the service request in the SDP; and
a capability access subsystem configured to determine a service capability called by the service request, and convert the service request into an interface supported by a service capability module that provides the service capability.

10. The SDP according to claim 9, further comprising a service logic processing subsystem configured to process service logic that needs to be executed by the SDP.

11. The SDP according to claim 9, wherein the service access subsystem is further configured to perform service level agreement (SLA) control.

12. The SDP according to claim 9, wherein the service access subsystem performing access authentication on the SP specifically comprises that the service access subsystem performs access authentication on the SP according to an identity spId for which the SP applies on the SDP and a password spPassword which the SP set on the SDP, wherein the identity spId and the password spPassword are comprised in the public information.

13. The SDP according to claim 11, wherein the service access subsystem performing service level agreement (SLA) control comprises the service access subsystem performs service-level SLA control according to a service identifier serviceId corresponding to the service request, wherein the service identifier serviced is comprised in the public information, and performs SP-level SLA control according to the identity spId for the SP applies on the SDP, wherein the identity spId is comprised in the public information.

14. The SDP according to claim 9, wherein the integrated bus subsystem determining routing of the service request in the SDP specifically comprises that the integrated bus subsystem determines routing of the service request in the SDP according to the operation ID identifier operateId comprised in the public information.

15. The SDP according to claim 9, wherein the capability access subsystem determining the service capability called by the service request, and converting the service request into the interface supported by the service capability module that provides the service capability specifically comprises that the capability access subsystem determines, according to the operation ID identifier operateId comprised in the public information, a service capability called by the service request, determines a protocol conversion rule according to the operateId, and converts, according to the protocol conversion rule, the service request into an interface supported by the service capability module that provides the service capability.

16. The SDP according to claim 10, wherein the service logic processing subsystem determining service logic that needs to be executed by the SDP specifically comprises that the service logic processing subsystem determines, according to the operation ID identifier operateId comprised in the public information, service logic that needs to be executed by the SPD.
